(19) United States
(12) Patent Application Publication
(10) Pub. No.: US 2007/0112617 A1
(43) Pub. Date: May 17, 2007

(54) Marketing system for a niche business

(76) Inventor: Pat Necerato, Howell, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/591,953

(22) Filed: Nov. 2, 2006

Related U.S. Application Data
(60) Provisional application No. 60/736,888, filed on Nov. 14, 2005.

(51) Int. Cl. G06F 17/30

(52) U.S. Cl. 705/10

(57) ABSTRACT

A marketing system having one or more modules with instructions for execution on a computer system. In one embodiment the system has a client database module for managing client information. The system also has a module for generating advertising material based upon customer information input into the system. The advertising material identifies at least one Web address. The system also has one or more solicitation Web pages associated with the Web address. The solicitation Web pages are configured to obtain client information. The system also includes a link from said solicitation Web page to said client database module to update said client database module with said obtained client information.

This application claims the benefit of U.S. Provisional Application No. 60/736,888, filed Nov. 14, 2005, the disclosure of which is hereby incorporated herein by reference.

### BACKGROUND OF THE INVENTION

A typical business expends significant resources in terms of both time and money to attract clients to its business and to retain those clients. Businesses, especially small businesses, can be stretched to the limit in terms of time and capital required to cultivate and maintain an adequate client base. The cost of generating and placing advertisements can be significant and the time and cost associated with new client solicitation, intake and client retention can significantly reduce the amount of time a small business can devote to making its products or providing its services.

There are many resources that a small business can draw upon for assistance in marketing for new clients. However, these resources tend to be expensive and specialized. While the tools are numerous they may not be compatible. For example, a company that will provide art services for generating ads will typically not have the expertise to provide the small business with internal procedures for generating and keeping clients. Also, while there are many software packages that can be used for keeping track of client information, appointments, etc. these packages are typically not fully integrated with other services/tools that a small business might use to generate and maintain its client base.

Accordingly, tools that a small business might use to market and sell its products/services to expand its client base and retain its clients continue to be sought.

### SUMMARY OF THE INVENTION

The present application provides an automated marketing system that is particularly suited to small or niche businesses. The marketing system has one or more modules having instructions for execution on the computer system. In one embodiment the system has a client database module for managing client information. The system also has a module for generating advertising material based upon customer information input into the system. The advertising material identifies at least one Web address. The system also has multiple solicitation Web pages associated with the Web address. The solicitation Web pages are configured to obtain client information. The system also includes a link from said solicitation Web page to said client database module to update said client database module with said obtained client information.

Alternatively or in addition to the Web pages, the advertisement material can reference a phone number associated with the customer's business. The phone number is assigned to the customer by the system. The system links the phone number to a phone message system module. This module provides information to a caller (i.e. a potential client) in an audio format regarding the customer's business. The phone messages system is a call mailbox (e.g. audix or some other automated answering service) that will accept and audio message from the client and will prompt the client for contact information. The system will automatically forward the audio messages to the client. In one embodiment, the information is forwarded as an audio text file via email. In an other embodiment, the messages are stored in a file that links to the customers administration web page (described in detail below).

The present application also provides a method of generating an automated marketing system for a niche business and an automated method for marketing a niche business. The method of generating such system includes the gathering of customer information regarding the niche business and configuring a module for generating advertisements in support for the niche business. The method also includes the generation of at least one Web page that cooperates with one or more modules for gathering and maintaining client information. The at least one Web page is a client solicitation module that provides a promotional item in exchange for client information.

The automated method for marketing a niche business includes generating advertising material as above and using at least one solicitation Web page to gather client information. In preferred embodiments, the clients are automatically contacted using the client information. The solicitation Web page can offer the client a promotional item, for example a free report or a complimentary visit, in exchange for client information. The system also generates a report upon receipt of the client information.

In a further embodiment, the solicitation Web page generates a confirmation of said complimentary visit upon receipt of client information. In still further embodiments, the method provides a customer with a link for allowing the customer to enter client information into the client database for use by the system. The method may further use a client referral Web page and provide an existing client with a link to the client referral Web page. Additionally, the referral Web page may request and obtain new client information related to a second client entered into the client referral Web page by an existing client. The new client information can be stored in the client database for further processing.

The techniques of the present application provide a niche or small business with the capability to market and sell its products/services to maintain and expand its current client base in a fully integrated way without expending large amounts of personal time on these activities. For example, the techniques generate advertisement material related to health services provided by the niche business. The advertisement material provides a link to the solicitation Web pages which provides further incentives for a potential client to seek the services of the business. The Web pages gather client information which can be used for further processing such as sending automatic and periodic follow up emails to the client. Thus, the technique handles various marketing tasks in an automatic manner, allowing the customer to focus more on providing health services. Moreover, the referral techniques of the present application may help increase the existing client base by having existing clients refer new clients to the practice. In addition, the techniques provide a customer with access to the client information in the database to further market to the clients in an automatic and periodic manner.

### BRIEF DESCRIPTION OF THE DRAWINGS

FIG. 1 is a flow diagram of a method of generating a web-based marketing system according to an embodiment of the present application.

FIG. 2 is a diagram of a solicitation Web page of the marketing system according to an embodiment of the present application.

FIG. 3 is a diagram of a report Web page of the marketing system according to an embodiment of the present application.

FIG. 4 is a diagram of a referral Web page of the marketing system according to an embodiment of the present application.

FIG. 5 is a diagram of advertisement material according to an embodiment of the present application.

FIG. 6 is a block diagram of the web-based marketing system with modules according to an embodiment of the present application.

FIG. 7 is a flow diagram of the operation of the solicitation module of FIG. 6 according to an embodiment of the present application.

FIG. 8 is a flow diagram of the operation of the new client contact module of FIG. 6 according to an embodiment of the present application.

FIG. 9 is a flow diagram of the operation of the missed prospect module of FIG. 6 according to an embodiment of the present application.

FIG. 10 is a flow diagram of the operation of the lead generation module of FIG. 6 according to an embodiment of the present application.

FIG. 11 is a flow diagram of the operation of the main client list module of FIG. 6 according to an embodiment of the present application.

FIG. 12 is a flow diagram of the operation of the automated appointment module of FIG. 6 according to an embodiment of the present application.

FIG. 13 is a flow diagram of the operation of the client reactivation module of FIG. 6 according to an embodiment of the present application.

FIG. 14 is a flow diagram of the operation of the client message module of FIG. 6 according to an embodiment of the present application.

FIG. 15 is a diagram of an administration panel according to an embodiment of the present application.

### DETAILED DESCRIPTION

Described herein is a marketing system for attracting clients to a niche business and retaining those clients. In one embodiment, the marketing system is a client/server computer system configured to operate over a computer network such as the World Wide Web (“Web”) or other network. Aspects of the invention that include integration of the marketing system with the Web and the automated generation of Web page(s) used in the system are readily understood by one skilled in the art and not described in detail herein.

By way of background the following are definitions of the terms used herein.

Internet is a collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

World Wide Web (“Web”) is used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

Web site or Web page is a computer system that serves informational content over a network using the standard protocols of the World Wide Web. Typically, a Web site corresponds to a particular Internet domain name, such as “amazon.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

URL (Uniform Resource Locator) is a unique address which fully specifies the location of a file or other resource on the Internet. The general format of a URL is protocol://machine address:port/path/filename. The port specification is optional, and if none is entered by the user, the browser defaults to the standard port for whatever service is specified as the protocol. For example, if HTTP is specified as the protocol, the browser will use the HTTP default port of 80.

The marketing system is configured to provide advertisement material related to the niche business where the advertisement material includes a link (as used herein a link is either a live link or a printed web address) to Web pages associated with the niche business. Alternatively or in addition to the Web page link, the advertisement material can include a phone number associated with the customer's business. The phone number is linked to a phone message system that provides information in an audio format regarding the customer's business and allows the client to leave contact information by leaving a message with the system. The system forwards these messages to the customer for follow-up.

The advertisements are placed in conventional channels (e.g. print media, electronic media, etc.) In this manner, clients and potential clients receive the advertisement material and are directed to access more information about the niche business via the Web pages which the marketing system is also configured to create and provide. In addition, potential clients can be directed to information about the business via the phone number linked to the phone message system.

As used herein, a niche business refers to a segment of a market related to an occupation, profession, or trade. For example, a niche business may include a chiropractic practice that provides health related services for treating various health problems. To illustrate, the marketing system of the present invention is described in the context of a chiropractic practice. However, it is contemplated that the marketing system can be used in the context of other niche businesses such as a health club and/or a spa.

Further, for ease of description of the present application, the following additional definitions are employed. A client or active client refers to an individual who currently receives the services of the niche business, a prospective client refers to an individual who may be interested in receiving the services, and an inactive client refers to an individual who received services in the past but does not currently receive those services.

A customer refers to an individual (or organization) that provides the goods/services associated with the niche business. The customer uses the marketing system to manage current clients, attract prospective clients and reactivate inactive clients. Often the customer is the owner of the business.

A vendor is an individual (or organization) who provides the marketing system to a customer to allow the customer to manage clients for the customer's business. The vendor provides the system to the customer in exchange for payment by the customer.

In one embodiment, the marketing system allows customers to maintain current clients as well as attract prospective clients for the niche business in a cost effective and efficient manner. The marketing system is a web-based electronic system that includes program modules that automatically generate advertisement and/or promotional material and Web pages related to the niche business. The advertisement material includes links (e.g., hyperlinks, printed web address) that direct clients to the Web pages. As an alternative or in addition to the Web page link, the advertisement material can include a phone number linked to a phone message system that provides information regarding the customer's business and allows the client to leave a message and contact information for further processing.

The advertisement material is generated using predefined templates. The system is configured to receive customer information and generate print ads based upon the received information and the ad templates. The print ads are printed out in hardcopy or provided electronically for customer use. Generating ad copy using predefined templates is easily practiced by one skilled in the art. Consequently, the generation of advertisement materials using predefined templates is not further described herein. The primary function of the advertisements is referral of customers to the one or more Web pages associated with the Web-based system or the phone message system associated with the phone number. As such, the advertisements typically feature the web address(es) of the Customer Web Page(s) generated by the system.

The system also creates Web pages for the customer's use to grow the client base and to keep existing clients. Again, building Web pages (e.g. obtaining a URL; designing the Web page, etc.) is conventional technology and not described in detail herein. Exemplary functions performed by the Web pages in support of the various system modules are described in detail below. One skilled in the art is well aware of the techniques required to generate Web pages with the described functionality. As such, methods for generating the Web pages with the specified functionality are not described in detail herein.

The Web pages typically require the client visiting the Web page to enter contact information if the client wishes to receive further information regarding the niche business. The system captures the client contact information into a client database for storage and for further processing. In one embodiment, the client database is resident in the system. In another embodiment, the client database is separate and apart from the system, but the information is communicated from the database to the system and vice-versa using a module for communicating client data to and from the system. For example, the customer can access the database for various purposes including following up with the clients. Below a description is provided of a method of generating the Web-based marketing system as well as the marketing system and the program modules.

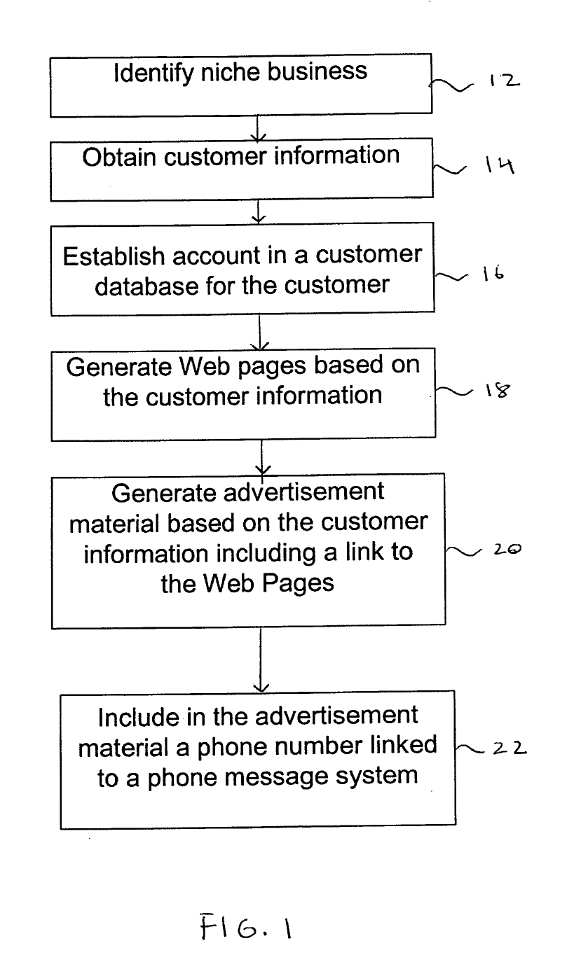

FIG. 1 is a flow diagram of a method of generating a Web-based marketing system according to an embodiment of the present application. The method of generating the marketing system for a customer employs an advertising program which serves as a key component of the marketing system generated for the customer. In step 12, a niche business is identified by the vendor of the marketing system. For example, the vendor may conduct market research based marketing techniques to identify a niche business such as a chiropractic practice. In step 14, the vendor obtains from the customer information regarding the niche business. For example, in the chiropractic practice, the customer may indicate that the practice provides health services directed to treating various health problems such as back pain relief, headache relief, carpal tunnel syndrome, fibromyalgia relief, work injury, car accident injuries neck pain relief and other problems. In step 16, the system establishes an account for the customer and stores the customer information in a customer database for further processing. As explained below, the customer information is used by the system to generate advertising material as well as Web pages for use by the customer in the Web based system. Moreover, the customer database allows the vendor to track the customer's activity such as payment for using the marketing system.

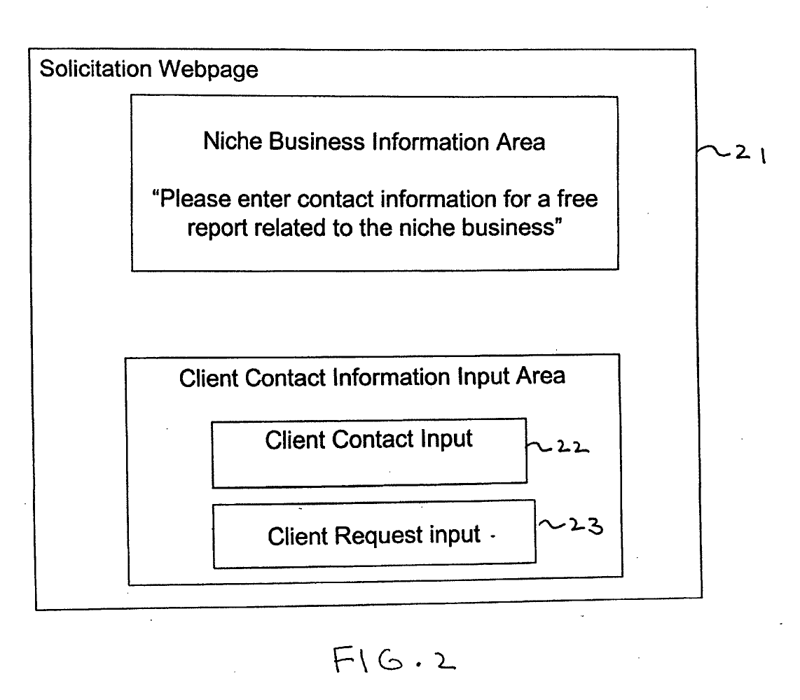

Once the customer information has been obtained and stored, the marketing system, in step 18, generates one or more Web pages. In one embodiment, the system generates a plurality of Web pages. Examples of such Web pages are a solicitation Web page, one or more solicitation and report Web pages and a referral Web page. All Web pages relate to the niche business. The Web pages are generated based on the customer information. For example, FIG. 2 shows a solicitation Web page 21 that the system generates for each of the services or products provided by the niche business. In the chiropractic practice, the system can generate solicitation Web pages directed to health services provided by the chiropractor for treating various health problems such as back pain and work injury. The solicitation Web page provides an input means such as text fields 22, 23 for a client to enter contact information and allow the system to capture such information into a client database (not shown) for further processing. For example, the client contact information can include the clients name, phone number, email address. The contact information also can include a request for further information regarding the niche business. In the chiropractic practice, such a request can include a request for a free report providing information relating to a particular health problem such as back pain. Typically, the request is associated with the health service to which the solicitation Web page is directed.

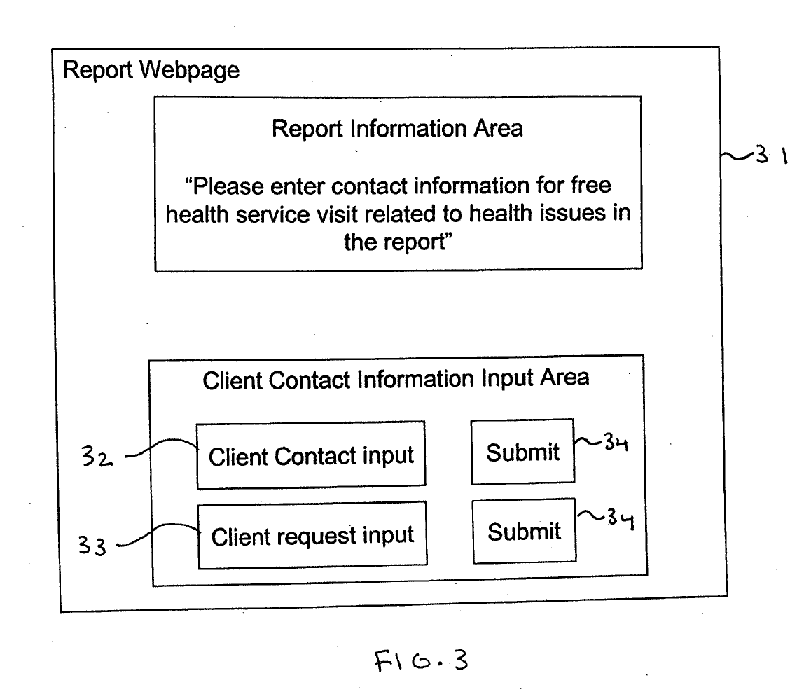

In one embodiment of the system, the request from the solicitation Web page directs the client to a report Web page 31 related to the particular health problem. For example, FIG. 3 shows a report Web page 31, which, like the solicitation Web page 21, provides an input means such as text fields 32, 33 and submit buttons 34 to allow a client to enter contact information and allow the system to capture and store in a client database for further processing. The contact information also can include a request for the services 33 provided by the niche business.

For example, in the chiropractic practice, the request for health services is typically a request for the chiropractor to treat a particular health problem. For instance, the client can request a free initial consultation for treating back pain.

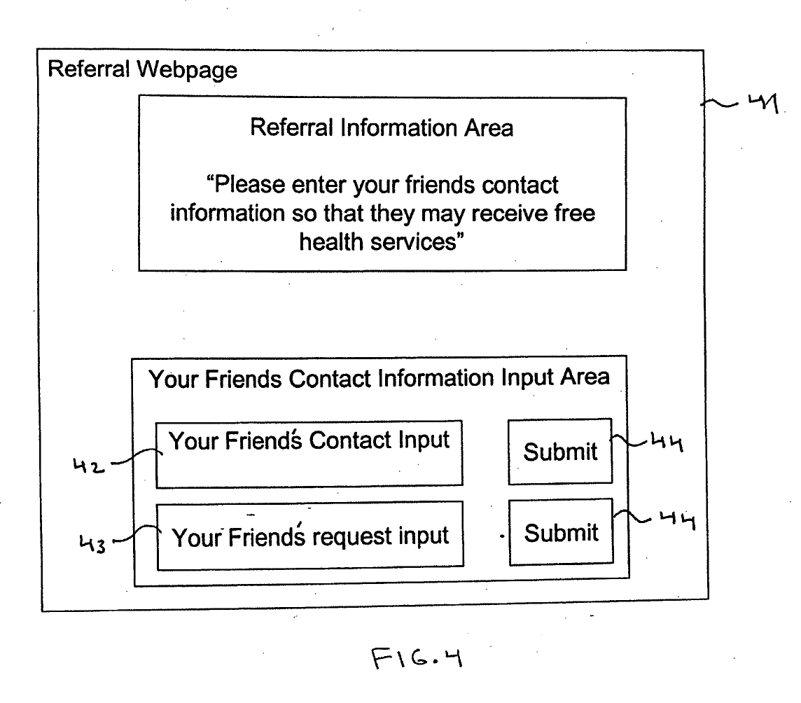

A referral Web page 41 allows existing clients to use the marketing system to refer friends of the client as new clients to the niche business. For example, FIG. 4 shows a referral Web page 41, which like the solicitation Web page, provides an input means such as text fields 42, 43 and submit buttons 44 that allow the client to enter a friend's contact information which can be captured in a client database by the marketing system for further processing. The contact information also can include a request for services provided by the niche business. For example, in the chiropractic practice, such as a request can include a request for a health services provided by the chiropractor.

Referring back to FIG. 1, once Web pages have been generated, then in step 20, the marketing system can generate advertisement material directed to the niche business of the customer. For example, the advertisement material includes information about the niche business such as services provided by the business. The information also can include contact information for contacting the niche business such as links (hyperlinks) to the Web pages provided by the system. The advertisement material can include online or offline media such as advertisement flyers, newspaper advertisements, brochures, letters, postcards or other advertisement media.

In step 22, the marketing system includes a phone number with the advertisement material. In this embodiment, upon receiving the customer information, the system obtains a phone number for a voice message mailbox that is linked to the customer's account. The technology needed to obtain such a number for a centralized phone message system based upon the customer information is well known to one skilled in the art and not described in detail herein. The phone number can be a toll free number which is assigned to the customer once the marketing system has established an account for the customer as explained above. The phone message system can be a voice mail system which provides a menu of options such as an option for receiving or requesting information regarding the customer's business, leaving a message including client contact information such as phone number of the client as well as other options as required by the application. As explained below in detail, the message information (that can include client contact information) is stored in a separate client voice message database and linked to the administration page and/or stored in the client database for further processing.

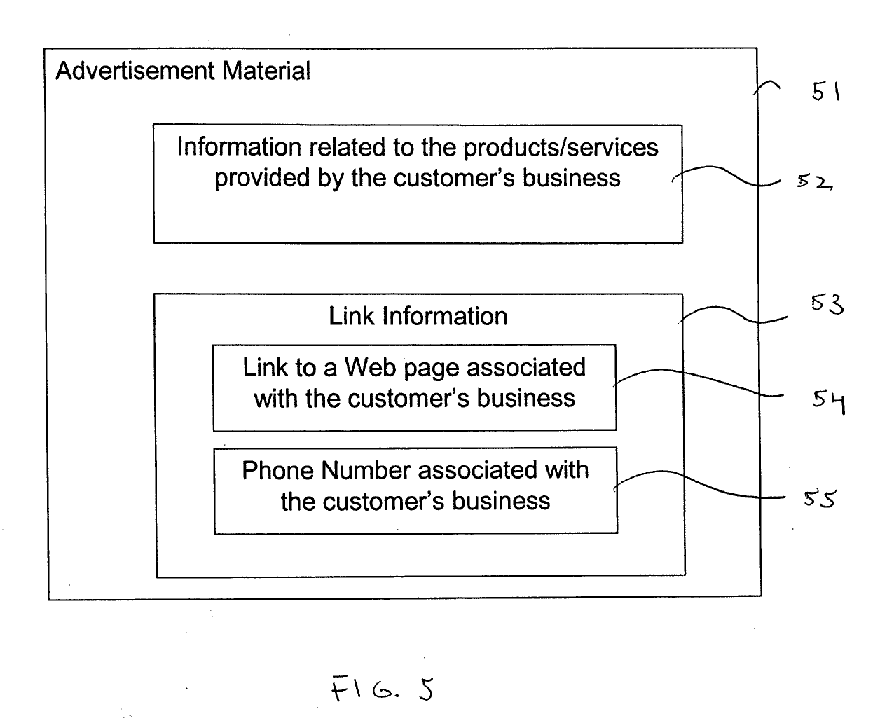

FIG. 5 is a diagram of advertisement material 51 according to an embodiment of the present application. In a preferred embodiment, the advertisement material 51 is in the form of an advertisement flyer with a customer information section 52 and a customer business link section 53. As explained above, the system generates the advertisement material based on information related to the customer's business. The customer information section 52 can include a description of products/services provided by the customer's business. For example, in the chiropractic practice, the customer information section 52 can include a description of health related symptoms such as back pain and offer a free report further explaining back pain or suggestions for relieving back pain. The customer link section 53 can include a Web link 54 such as a Web address directing a client to a solicitation Web page containing the free report as explained above. Alternatively or in addition to the Web page link 54, the customer link section 53 can include a phone number link 55 linked to a phone message system. The phone message system is configured to allow a potential client to request the same customer information described above except via an audio link instead of a web link. As explained above, once the customer is directed to the solicitation Web page and enters client contact information and/or directed to the phone message system and leaves a phone message with client contact information, the marketing system can obtain the client contact information for further processing in accordance with the techniques of the present application.

Other aspects of the system are generated at this time including, but not limited to, the client database, the client appointment management module and the client reactivation modules. These modules are described in greater detail below in the context of using the Web-based system.

At this point in the process, the marketing system has been generated. The next step is to have the customer or other individual distribute the advertisement material to prospective clients and use the system. Once the prospective clients receive the advertisement material, they may decide to visit the Web pages indicated on the advertisement material. For example, in the chiropractic practice, the advertisement material includes a link to a solicitation Web page which allows a client to request a free report related to a particular health issue in exchange for client contact information. Once the client requests the free report, the client is directed to the free report Web page which provides further information directed to the particular health issue. Furthermore, the free report Web page provides the client with the opportunity to request a promotional item such as a free health service (e.g., consultation) in exchange for additional contact information. The client contact information is stored in the client database 102 (FIG. 5) to allow for further processing by the customer including following up with the client, as explained in further detail below.

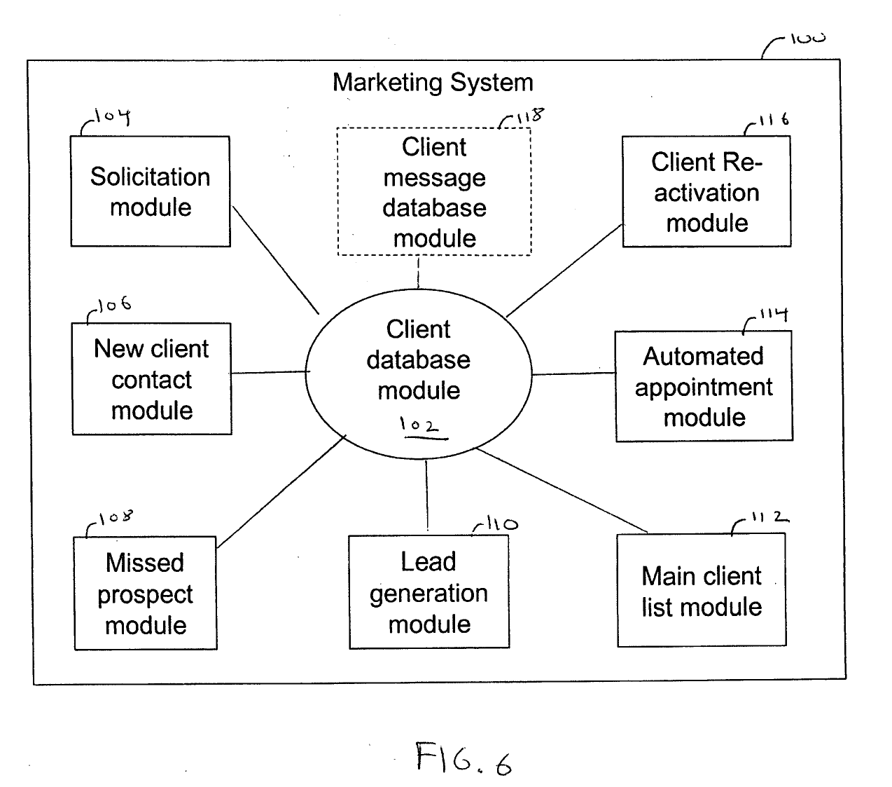

FIG. 6 is a block diagram of a marketing system with program modules according to an embodiment of the present application. In one embodiment, the marketing system 100 is a client/server computer system configured to operate over a computer network such as the Web. The marketing system 100 is configured as a server that also hosts program modules 102-118 to implement the system. Different users such as clients, customers and the vendor can access the marketing system via client computers (e.g., personal computers (either desktop, laptop or handheld)) configured with Web browsers for communication over the Web.

In the embodiment illustrated in FIG. 6, the program modules 102-118 are configured as a hub and spoke architecture with client database program module 102 representing the hub and the other program modules 104-118 representing the spokes of the architecture.

The client database module 102 includes software functionality for generating and maintaining a client database (details not shown). One skilled in the art is very much aware of how to build such a database and the database is not described in detail herein. The client database module 102 stores client information obtained from the system, such as from the Web pages provided by the system, and also, optionally, sends the client information to the customer's client database. In preferred embodiment, the client database synchronizes with the customer database containing client contact information.

The solicitation module 104 interacts with the client database module 102 to capture and store client information obtained from clients via the Web pages generated by the system. When a client enters information into the solicitation module, that data is forwarded to the client database module for use by the customer and use by the system. The module sends a notification to the customer of the client's request for services. The information can be used by the customer, such as, for example, to set up appointments for the clients.

The new client contact module 106 interacts with the client database module 102 such that the customer can enter new client information, update existing client information and generally synchronize the client information to the client database. The new client contact module can also be used to automatically generate and send various messages to those new clients.

The missed prospect module 108 interacts with the client database module 102 to determine those prospective clients that failed to become current clients. The missed prospect module is configured to automatically send various messages to gain the interest of the prospective clients via reminders and promotions or other incentives and thereby encourage the clients to become active clients.

The lead generation module 110 interacts with the client database module 102 to enter client information related to prospective clients into the customer database. These leads can be provided from a variety of sources both inside and outside the system. For example, if a customer obtains potential client contact information at an event, that information can be input into the lead generation module and further input into the client database. Similarly, referral information entered into the system via the referral Web page will be entered into the client database module. The new client contact module will identify the new clients in the client database module and automatically send various messages to encourage the clients to become new clients.

The main client list module 112, as described above, interacts with the client database module 102 to allow the customer to synchronize the client information in the customer's conventional system with the client information in the client database. Again, the module is used to automatically send various marketing messages to those clients identified in the module. The marketing messages can include a monthly newsletter. This newsletter can be customer generated or generated by templates within the system much as the templates are used to generate the advertising materials as previously described.

The automated appointment module 114 interacts with the client database module 102 to automatically send reminder messages to remind the clients of an upcoming appointment. The information regarding client appointments is either stored in the client database module or downloaded into the client database module from the customer's client records. The automated appointment module automatically sends out appointment reminders to clients on the customer's appointment calendar. The reminders can be sent with a request confirming receipt to even better manage appointments on the calendar.

The client reactivation module 116 also interacts with the client database module 102. This module manages the customer's older client list and either allows the customer to identify inactive clients or searches the client database for inactive clients. Once the module identifies inactive clients, the module automatically sends messages tailored to encourage those clients to become active clients.

The client message database module 118 gathers client information from a phone message system (not shown) that stores messages from clients via a phone number. The client message database module 118 can store the message in a client message database separate from the client message database module 102. In addition or alternatively, the client message database module 118 can convert the message into client information in a format compatible for storing the information in the client database module 102 and store the information in the module 102. The client information gathered from the phone message system is used in the same manner as client information gathered by the other mechanisms described herein.

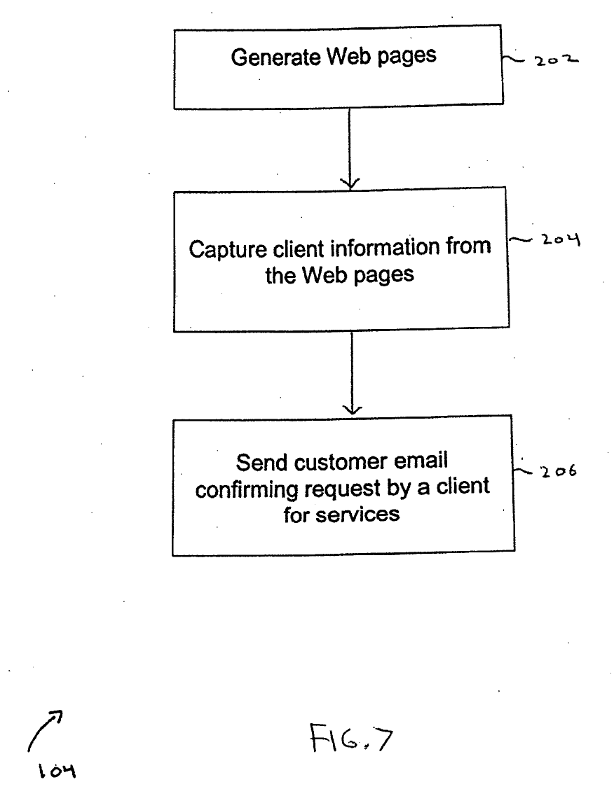

The FIG. 7 is a flow diagram of the creation and the operation of the solicitation module 104 of FIG. 6 according to an embodiment of the present invention. In step 202, the system generates the Web page(s) as previously explained above in reference to FIG. 1 and the description thereof. The Web pages allows a client to enter client contact information and request for services provided by the niches business. In step 204, the module 104 interacts with the client database module 102 to capture the client information and store it in the client database. In step 206, the solicitation module sends the customer email messages confirming that the client has requested services provided by the niche business. For example, in the chiropractic practice, the request can include a request for a free consultation related to a particular health issue. The module may also automatically send sequential follow-up email messages to the client over a period of time.

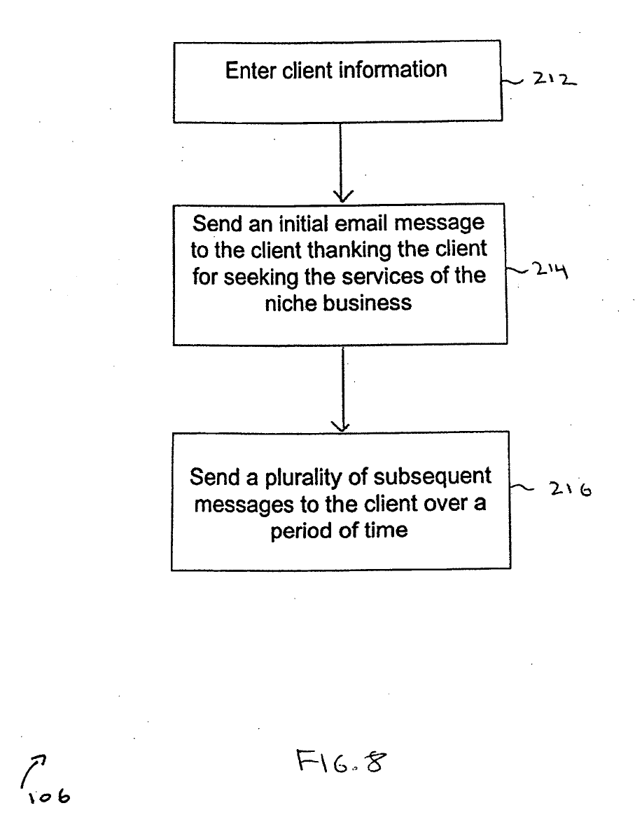

FIG. 8 is a flow diagram of the creation and operation of the new client module 106 of FIG. 6 according to an embodiment of the present application. In step 212, the customer interacts with the client database module 102 by entering client information related to new clients. In step 214, the module automatically sends a first personalized email message to the client thanking the client for requesting the services of the niche business. In the chiropractic practice, for example, the message can thank the client for seeking chiropractic services provided by the chiropractor. Once the first message is sent, the module, in step 216, automatically sends one or more pre-written, automated, customized email messages over a period of time such as one year. These messages help the client remain interested and excited about the decision to seek the services of the niche business. The messages can include a series of online courses related to the services provided by the niche business. For example, in the chiropractic practice, the message can consist of a health related course or information explaining the secrets to healthy living.

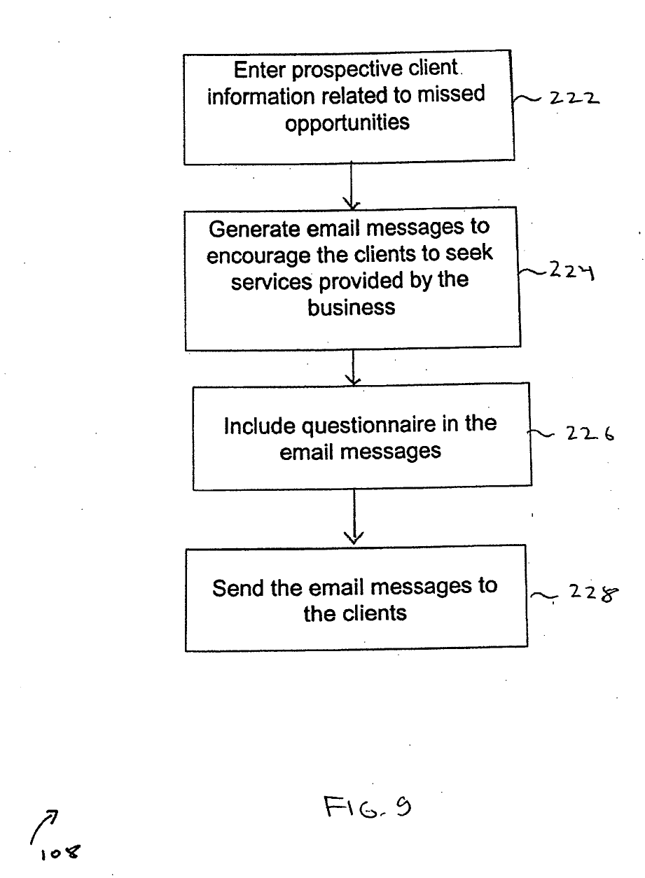

FIG. 9 is a flow diagram of the operation of the missed prospect module 108 of FIG. 6 according to an embodiment of the present invention. In step 222, the customer interacts with the client database module 102 by entering client information related to prospective clients that failed to become current clients. For example, in the chiropractic practice, the customer may have performed an unsuccessful spinal screening conversion, a report of findings for which the client did not follow up or any client contact that did not result in return visits. Other examples include previous free consultations and prospective client interviews but did not result in further client contact. The system allows the user to enter the client information related to missed opportunities that have occurred over a period of time (e.g. two years). In step 224, the module automatically generates a plurality of pre-written, automated messages encouraging the prospective clients to seek the services of the niche business. In step 226, the module inserts into the messages a client questionnaire. The questionnaire solicits from the client the reasons why the client stopped seeking services. In step 228, the email messages are sent to the prospective clients. The above techniques are part of a marketing campaign that help the customer convert prospective clients into new clients.

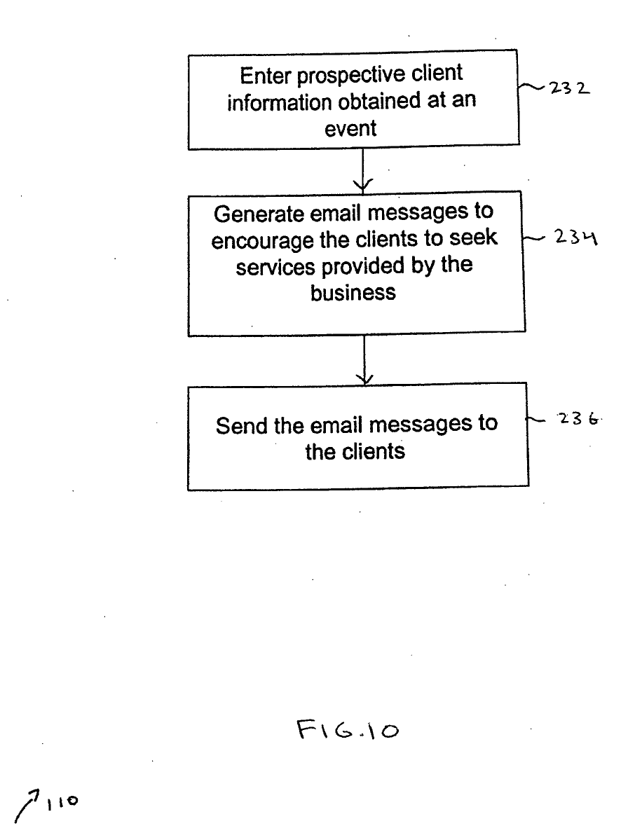

FIG. 10 is a flow diagram of the operation of the lead generation module 110 of FIG. 6 according to an embodiment of the present application. In step 232, the module receives prospective client information from the customer. The prospective client information is obtained from a variety of sources (e.g. an event or forum where the customer advertised the business). Further examples of such forums include trade shows, mall shows, speaking engagements, luncheons, seminars or any other event. The information input by the customer updates client database module 102. In step 234, the module 110 automatically generates various email messages to encourage the clients to become active clients. In step 236, the module sends the email messages to those clients. These techniques help the customer attract new clients to the business.

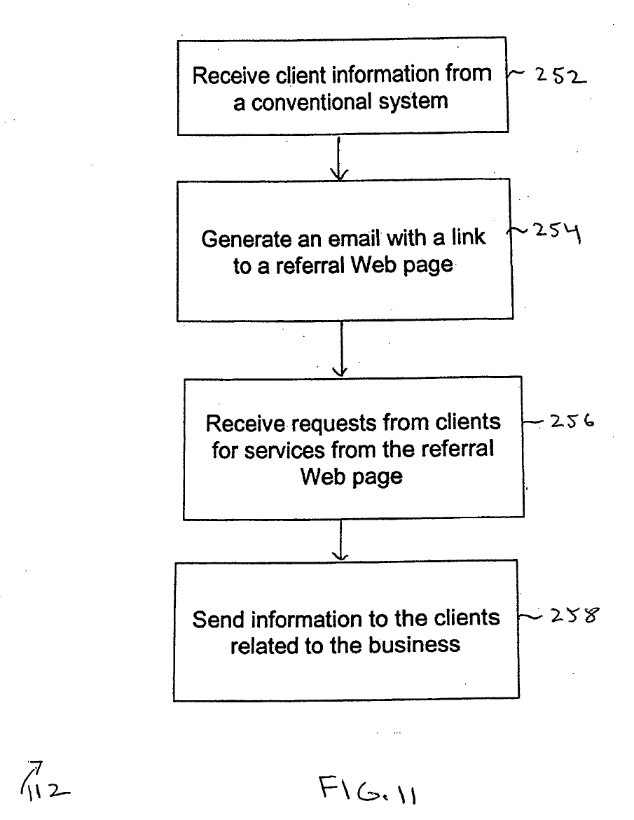

FIG. 11 is a flow diagram of the operation of the main client list module 112 of FIG. 6 according to an embodiment of the present application. In step 252, the client database module 102 is synchronized with the client information in the customer's conventional client contact system. Alternatively, the main client list module 112 allows the customer to manually enter client information into the client database module 102 from the customer's conventional client contact system. Alternatively, the module may provide a Web page to allow clients to request a monthly newsletter. The module captures this information into the client database for further processing. In this embodiment, the module uses that information to mine the existing client base for referrals to generate new clients. In step 254, the module 112 sends the current clients an email message which includes a link to a referral Web page previously described. When the clients access the Web page, the Web page solicits the current client to provide the customer with contact information for additional, potential new clients. For example, as explained above, in the chiropractic practice, the referral Web page allows a current client to refer friends of the client to the chiropractor for a free consultation. As an incentive, this module is configured to inquire about specific conditions and encourage referral if one or more of these conditions correspond to a condition of a friend or acquaintance of the current customer who might benefit from a referral. In step 256, the module 112 obtains or captures this client information from the referral Web page, including requests for services provided by the business. The request can include a free consultation or a free report related to the services provided by the business. In step 258, once the client information has been obtained, the module 112 allows the customer to communicate with those potential clients in numerous ways. For example, the module allows the customer to market products and services to those clients, maintain relationships with those clients, send reminders, market seminars, new ideas obtain referrals or other opportunities. The module can automatically send a monthly newsletter via email to the client.

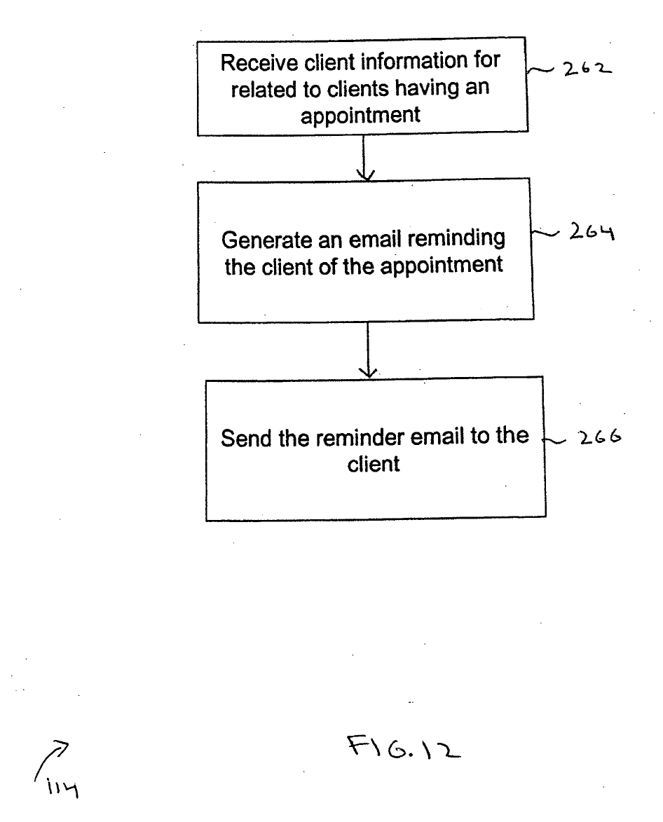

FIG. 12 is a flow diagram of the operation of the automated appointment module 114 of FIG. 6 according to an embodiment of the present application. In step 262, the customer (or, in an alternative embodiment, the customers electronic appointment calendar via electronic interconnection) interacts with the client database module 102. Specifically, appointment information is fed to client database module and enters client information related to current clients who have a scheduled an appointment for services provided by the niche business. In step 264, the module 114 generates email messages providing a reminder to the client of the upcoming appointment. In step 266, the module 114 sends the email messages to the clients. These techniques help reduce the number of canceled appointments and thus help improve the financial performance of the niche business.

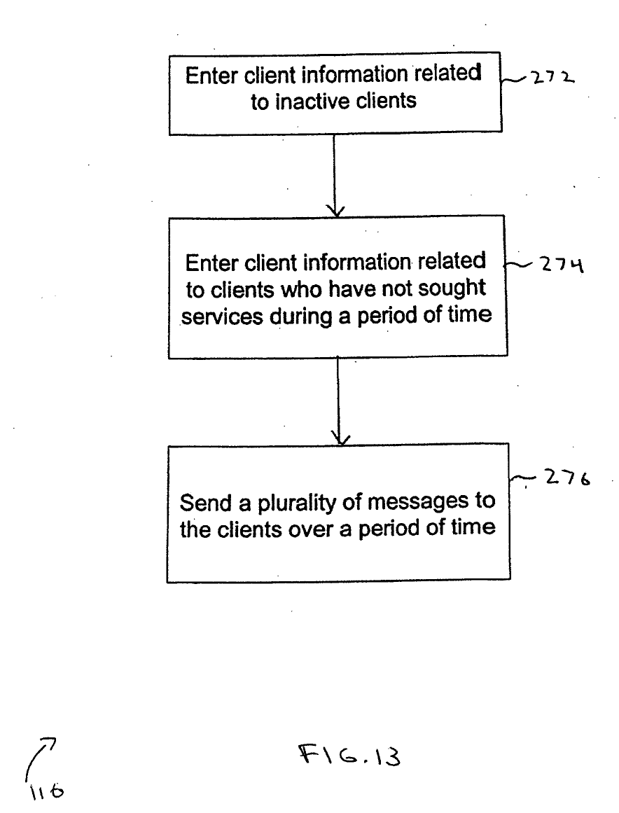

FIG. 13 is a flow diagram of the operation of the client reactivation module 116 of FIG. 6 according to an embodiment of the present application. In step 272, the module interacts with the client database module 102 by identifying inactive clients. The customer can also manually enter inactive clients into the module and the client information with respect to these inactive clients, to the extent present in the client database module 102, is used to reengage these clients. In step 274, the customer can identify inactive clients by searching the client database for clients that have not had an appointment for services for some period of time (e.g., six months). In step 276, the module sends to the inactive clients a plurality of messages over a period of time to motivate them to return and seek services provided by the business. The messages also can include a questionnaire having inquires directed to the prospective client as to why the client stopped seeking services. These techniques help the customer identify any possible issues related to the niche business and then address those accordingly and thus help improve the performance of the niche business. Such techniques are part of a marketing campaign that helps convert inactive clients into active clients.

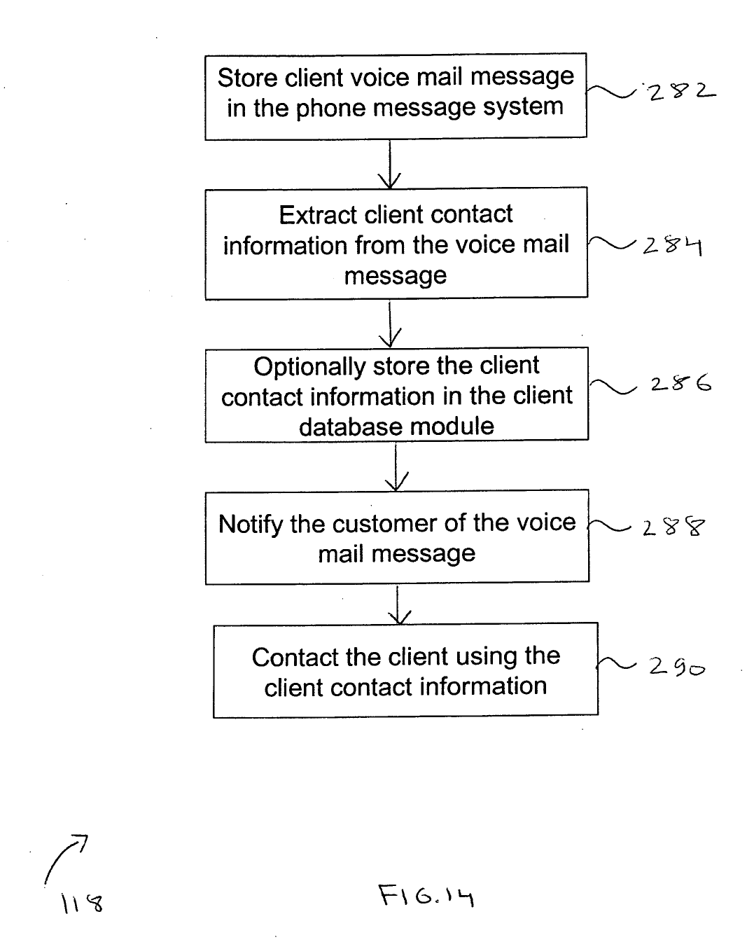

FIG. 14 is a flow diagram of the operation of the client message database module 118 of FIG. 6 according to an embodiment of the present application. For illustrative purposes it is assumed that a potential client reads the advertisement material and decides to dial the phone number listed on the advertisement material discussed above. The phone number is linked to a phone message system such as a voice mail system, which is well known to one skilled in the art and not described in detail herein. The phone message system can be configured to provide various menu options that can be selected by the client via touch tone buttons on the client's phone. For example, the phone message system can provide a description of the various products/services provided by the customer's business and allow the client to request further information regarding particular product/service by entering a touch tone buttons. The phone message system also can allow the client to leave a message including client contact information such as the client's phone number.

In step 282, the client message database module 118 stores the client message as a voice mail message in the phone message system itself. The message can also be stored in a client message database and/or directly to the client database module 102. In optional step 284, the module 118 automatically extracts client contact information such as the client name and phone number from the voice mail message.

For example, the module 118 can employ voice to text conversion techniques well known in the art to analyze the voice message and produce text based on the analyzed voice. Once the client contact information has been extracted, the module 118, in step 286, can store the information in the client message database and/or in the client database module 102. In step 288, the module 118 notifies the customer of a client request based on the voice mail message. Notification can include sending the customer an email with an audio attachment containing the voice mail message. In addition, the email can include client contact information in text format that was extracted from the voice mail message. In step 290, the system, via module 118, contacts the client via email messages or any of the other techniques of the present application. In alternative embodiments, the customer simply contacts the client via traditional phone communications.

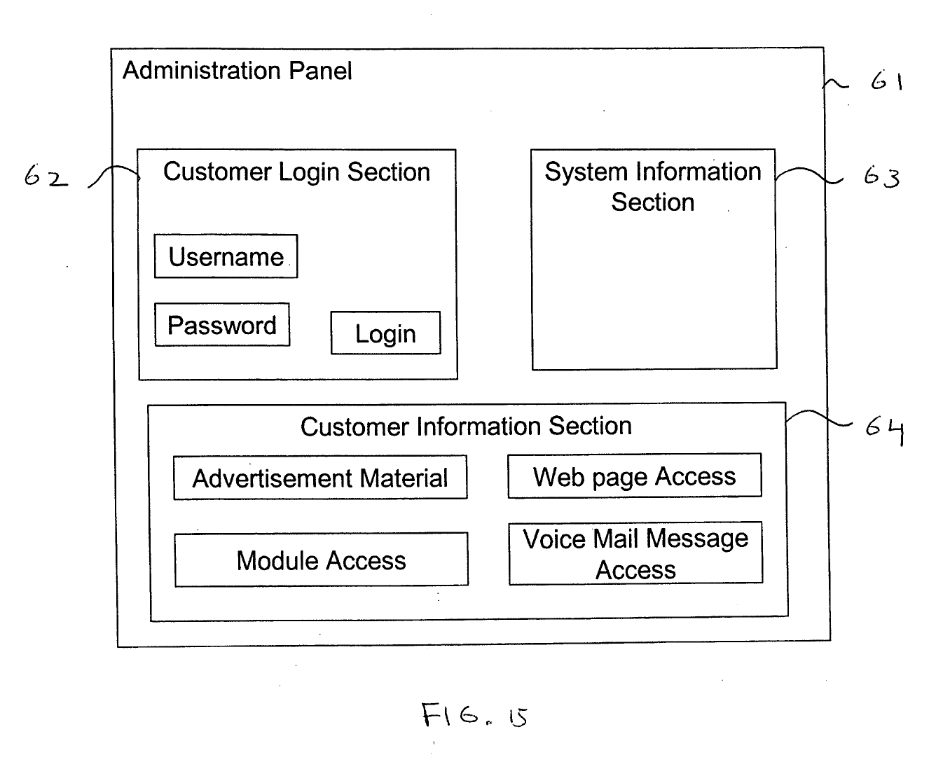

FIG. 15 is a diagram of an administration panel 61 according to an embodiment of the present application. In a preferred embodiment, the administration panel 61 is a Web page that allows a customer to manage and access the functionality of the modules 102-118 of the system. The Web page is accessible using a Web browser on a PC or other computer device. Generating such Web pages and configuring them is well known to one skilled in the art and not described in detail herein. The administration panel however can be implemented using other conventional computer based access techniques. The system sends an email to the customer with a link to the administration panel 61. The administration panel 61 may include a login section 62 to permit the customer to enter access/security information such as Username and Password information. A login button allows the customer to submit the information to the system which, upon verification, authorizes the customer to access the system via the panel. The panel 61 also may include a system information section 63 with links to Web pages containing system or vendor information related to the system. For example, the Web pages can include information describing new features of the system, important updates or alerts regarding the system or other system related information. The panel 61 may include a customer information section 64 with links that permit the customer to access various features of the system including the functionality of the modules 102-118 of the system. For example, the links may direct the customer to other Web pages which may allow the customer to update and access client contact information in the client database, email messages, voice mail messages, newsletters, advertising material and Web pages generated by the system and other information that the customer may be interested in accessing.

Although the application herein has been described with reference to particular embodiments, it is to be understood that these embodiments are merely illustrative of the principles and applications of the present application. It is therefore to be understood that numerous modifications may be made to the illustrative embodiments and that other arrangements may be devised without departing from the spirit and scope of the present invention as defined by the appended claims.

1. A method for creating a marketing system comprising:
obtaining customer information relating to a niche business of the customer;
generating advertising material based on the obtained customer information; and
generating at least one client solicitation Web page based on the obtained customer information.

2. The method of claim 1 wherein the niche business includes a segment of a market related to an occupation, profession, or trade.

3. The method of claim 1 wherein the advertisement material identifies the web address of the solicitation Web page or includes a link to the solicitation Web page or both.

4. The method of claim 1 wherein the advertisement material is generated from the customer information using a template.

5. The method of claim 1 wherein the solicitation Web page displays first information related to the niche business.

6. The method of claim 1 wherein the solicitation Web page includes an interactive communication feature to gather client information.

7. The method of claim 6 wherein the client information includes contact information of the client.

8. The method of claim 7 wherein the contact information includes one or more of an email address, regular address, name and phone number of the client.

9. The method of claim 6 further comprising:
building a client database; and
storing the client information in a client database.

10. The method of claim 9 wherein the interactive communication feature offers the client a promotional item in exchange for first client information and further comprising generating a report upon receipt of first client information.

11. The method of claim 9 wherein interactive communication feature offers the client a complimentary visit in exchange for client information and further comprising generating a confirmation of said complimentary visit upon receipt of client information.

12. The method of claim 9 further comprising:
providing a system for periodically contacting the client using the client information in the client database.

13. The method of claim 12 wherein the client is contacted via email.

14. The method of claim 13 wherein the email is sent to the client based on client information stored in the client database.

15. The method of claim 10 further comprising sending the confirmation to the customer.

16. The method of claim 9 further comprising generating an administration Web page to allow the customer access to the client database.

17. The method of claim 9 further comprising generating a client contact feature wherein the client is automatically contacted based on client information in the client database.

18. The method of claim 9 further comprising providing the customer with a link allowing the customer to enter client information into the client database.

19. The method of claim 17 wherein the client contact feature sends emails to the client based on the client information retrieved from the client database.

20. The method of claim 17 further comprising:
generating a client referral Web page, wherein the client contact feature automatically provides an existing client with a link to the client referral Web page.

21. The method of claim 20 further comprising:
providing the client referral Web page with an interactive system for gathering new client information of a second client entered into the client referral Web page by the existing client.

22. The method of claim 21 further comprising storing the new client information in the client database.

23. The method of claim 1 further comprising generating a phone number for directing clients to a phone message system.

24. The method of claim 23 wherein the phone number is placed on the advertisement material.

25. The method of claim 23 wherein the phone message system stores client messages.

26. The method of claim 25 wherein the phone message system is configured to forward the stored client messages to the customer.

27. A marketing system comprising:
a system comprising program modules having instructions for execution on the computer system, the system comprising:
a client database module;
a module for generating advertising material based upon customer information, said advertising material identifying at least one Web address;
a solicitation Web page associated with said web address, said solicitation Web page configured to obtain client information; and
a link from said solicitation Web page to said client database module to update said client database module with said obtained client information.

28. The marketing system of claim 27 wherein the solicitation Web page includes an interactive communication feature configured to gather client information.

29. The marketing system of claim 28 wherein the interactive communication feature offers the client a promotional item in exchange for entering first client information and further comprising generating a report upon receipt of said first client information.

30. The marketing system of claim 29 wherein the interactive communication feature offers the client a complimentary visit in exchange for first client information and further comprising generating a confirmation of said complimentary visit upon receipt of said first client information.

31. The marketing system of claim 29 wherein the interactive communication feature is further configured to send a confirmation response to the customer upon gathering client information.

32. The marketing system of claim 27 further comprising a client contact feature configured to periodically contact the client using the client information in the client database.

33. The marketing system of claim 27 further comprising a client information entry feature that provides the customer with a link for entering client information into the client database.

34. The marketing system of claim 27 further comprising a client contact feature configured to automatically contact the client based on client information in the client database.

35. The marketing system of claim 34 wherein the client contact feature automatically contacts the client by email.

36. The marketing system of claim 27 further comprising a client referral Web page adapted to receive client referral information.

37. The marketing system of claim 36 wherein the client contact feature automatically provides an existing client with a link to the client referral Web page.

38. The marketing system of claim 27 wherein the client referral Web page includes an interactive communication feature for receiving new client information of a second client entered into the client referral Web page by the first client.

39. The marketing system of claim 38 further comprising storing the new client information in the client database.

40. The marketing system of claim 27 wherein the advertisement material includes a phone number linked to the customer.

41. The marketing system of claim 40 wherein the phone number is linked to a phone message system used to gather client information.

42. The marketing system of claim 41 wherein the client information is stored in a client message database.

43. The marketing system of claim 42 wherein the system forwards the client information to the customer.

44. A method of marketing comprising:
generating advertising material based on customer information relating to a niche business of the customer wherein said advertising material refers to at least one solicitation Web page;
using said at least one solicitation Web page to gather client information;
storing said client information in a client information database; and
automatically contacting clients using the client information.

45. The method of claim 44 further comprising offering the client, via the solicitation Web page, a promotional item in exchange for first client information and further comprising generating a report upon receipt of first client information.

46. The method of claim 45 wherein the promotional item is a free report or a complimentary visit.

47. The method of claim 46 wherein the promotional item is a complimentary visit and further comprising generating a confirmation of said complimentary visit upon receipt of said client information.

48. The method of claim 44 further comprising sending a confirmation of the automatic client contact to the customer.

49. The method of claim 44 further comprising contacting the client using the client information at predetermined time intervals.

50. The method of claim 44 further comprising directing the client to a phone message system by identifying a phone number in the advertising material.

51. The method of claim 50 further comprising using the phone message system to gather and store client information.

52. The method of claim 51 further comprising forwarding the client information to the customer.

53. The method of claim 52 further comprising contacting the client using the client information in the client message database.
